(19) United States
(12) Patent Application Publication
(10) Pub. No.: US 2024/0242564 A1
(43) Pub. Date: Jul. 18, 2024

(54) One/Nine

(71) Applicant: Siddharth Parikh, Lauderhill, FL (US)

(72) Inventor: Siddharth Parikh, Lauderhill, FL (US)

(21) Appl. No.: 18/341,717

(22) Filed: Jun. 26, 2023

Related U.S. Application Data
(60) Provisional application No. 63/356,871, filed on Jun. 29, 2022.

(51) Int. Cl. G07F 17/32

(52) U.S. Cl. CPC G07F 17/323; G07F 17/3288

(57) ABSTRACT

The invention ONE/NINE is a valid method for a new, unique proposition wager, intended as an addition to an existing primary game of chance, which must produce a sequence of outcomes, that are random and statistically independent, from a range of outcomes that are uniformly or non-uniformly arranged. Roulette as an example, allows patrons to place a bet within the area marked “ONE/NINE” on the game's wagering area, therefore predicting that the probability of the proceeding outcome is going to match one of the most recent nine outcomes and one of their nine distinct probabilities. If the subsequent outcome matches one of the most recent nine game outcomes which change dynamically in ascending order, then patrons who have made their wagers on the “ONE/NINE” proposition, are winners and awarded their winnings, in accordance with the predetermined calculated ONE/NINE probabilities payout chart.

### CROSS-REFERENCE TO RELATED APPLICATIONS

NA

### STATEMENT REGARDING GOVERNMENT SPONSORED RESEARCH OR DEVELOPMENT

NA

### FILE VIA THE On-line FILING SYSTEM (EFS-WEB)

Yes, The Initial Provisional Application

### STATEMENT REGARDING PRIOR DISCLOSURES BY THE INVENTOR OR A JOINT INVENTOR

To the best of my knowledge this here invention is unique and new.

### BACKGROUND OF THE INVENTION

There is a great demand, within the casinos live gaming industry, for innovative wagering concepts, that can be methodically and simply incorporated with ease, while insuring user friendly implementation and be workable as an addition to the traditional games of chance, such as the game of Roulette, Blackjack, Craps, Baccarat, Poker, Big 6 wheel, and such house banked games of chance. Our invention, titled One/Nine, is an innovative method of applying a new proposition wager concept, wherein the primary game of chance producing a range of random, but statistically independent outcomes. The concrete example of such a game, is the game of Roulette that is played within the casinos live gaming industry. The invention One/Nine will further enhance such games of chance, and help serve the demand from both the casino operators and the casino patrons.

(1) Field of the Invention: The invention of One/Nine is for the casinos Live table gaming industry. This invention is applicable within land based casinos, cruise ships casinos, online casinos, electronic terminal based casinos, and other venues where such games-of-chance are offered and played by patrons.

### (2) DESCRIPTION OF RELATED ART INCLUDING INFORMATION DISCLOSED UNDER 37 CFR 1.97 AND 1.98

To the best of my knowledge I am unaware of any existence of such an invention.

### A Brief Summary of the Invention

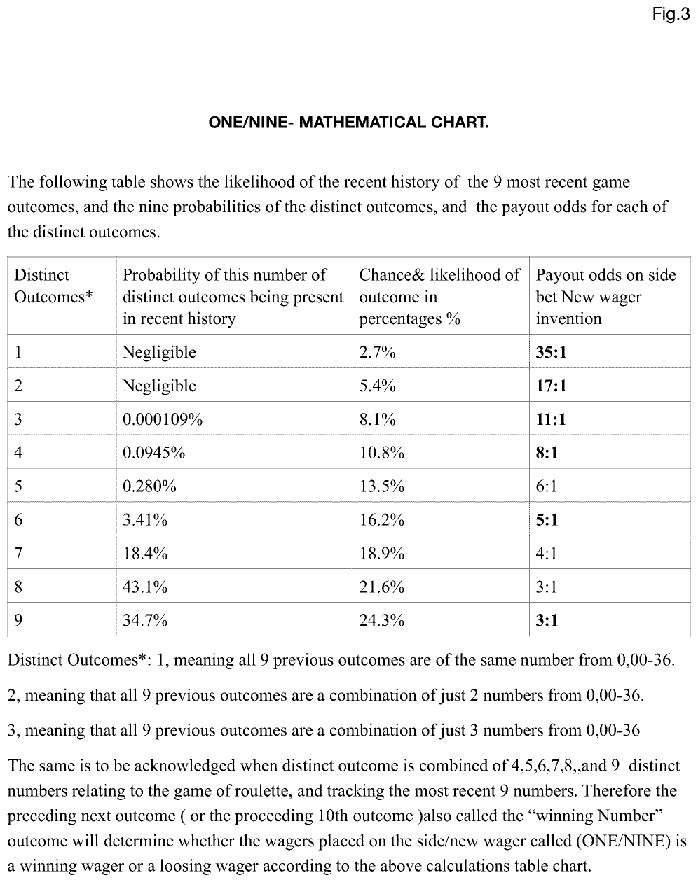

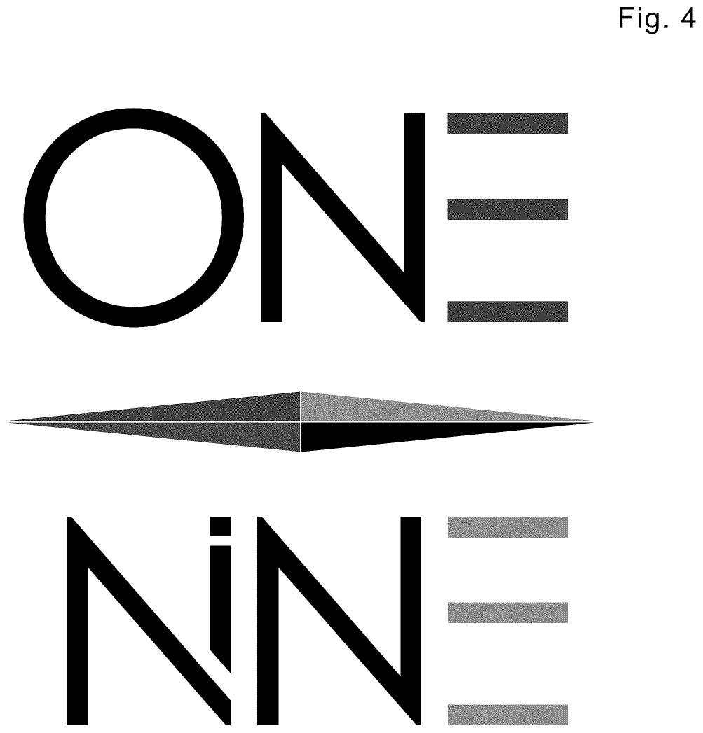

Invention One/Nine is an additional wagering concept/method that is integrated within an existing game-of-chance that produces sequence of game outcomes, where the outcome of each game event has a statistical-independent outcome. Such is true, in the game of Roulette, where the outcome of each game is a uniformly distributed random number from within the range of 37 or 38 numbers possibilities (between 0+1 to 36=37 numbers and or 0+00+1 to 36=38 numbers). This invention One/Nine wagering concept/method is an addition to such games of chance as Roulette. Patrons can participate by simply placing a wager using a casino chip or cash, on the game of Roulette wagering layout area, where the designated wagering area is marked ONE/NINE (see FIG. 2A and FIG. 2B). This additional One/Nine wager option can be played on a physical Roulette table, on any electronic terminal version, and on the online platform where such games are played.

The concept of the invention One/Nine applied to a game of chance such as the game of Roulette, is to predict by placing a wager, that the probability of the next winning game outcome is going to match One of the Nine most recent game outcomes that are always posted in their ever-changing dynamic form (meaning the most recent or the 10th winning game outcome will replace the first of the 9 most recent winning game outcomes, creating new most recent NINE game outcomes and so forth, before each new game event begins) each game outcome is statistically independent outcomes, and therefore, if the subsequent (or the 10th) winning game outcome is amongst the most recent NINE distinct game outcomes, that are always posted in their ascending order of occurrence on a display signage, then the patron/s who have made the wager on invention One/Nine wagering area are winners. The winning wagers are rewarded, and the appropriate winning amounts paid are in ratio to the value of the winning wager. The amounts paid out on the winning wagers are based on the winning number's distinction within the most recent Nine outcomes, and inline with the payout odds to the appropriate distinction. The payout odds are mathematically calculated based on probabilities that the next (or the 10th) upcoming winning game outcome could be matching ONE of the most recent NINE Distinct game outcomes.

The wagering for the Invention One/Nine concept/method could be placed in a form of a casino chip, or in cash, or in a digital currency, where the wagering area One/Nine is marked on a Roulette wagering layout (see FIG. 2A and FIG. 2B). The invention One/Nine can be played at any of these venues and platforms where such games of chance are played, as in a land based casino properties, or digitally at an online casino site, or on electronic wagering terminals.

The most recent Nine distinct game outcomes must always be posted on a display signage and in clear view, where the One/Nine wagering is offered to the patrons. The method of posting the most recent Nine winning game outcomes can be done manually, or posted automatically on an electronic display sign, or on a keypad inputted display sign. The “10th” and (momentarily) the active new winning game outcome must also be posted on these display signs so the operators can determine whether the 10th, and active winning game outcome is amongst the most recent Nine winning game outcomes or not, and if the 10th and the active winning game outcome is indeed amongst the most recent Nine winning game outcomes, then the display sign will also post the appropriate payout odds inline with the predetermined payout chart relative to the additional wagering concept/method of One/Nine. The distinct probabilities and the payouts chart must also be posted at each game site where the One/Nine wagering concept/method is offered to patrons.

### BRIEF DESCRIPTION OF THE SEVERAL VIEWS OF THE Figure(s)

There are the Figures attached with this application.

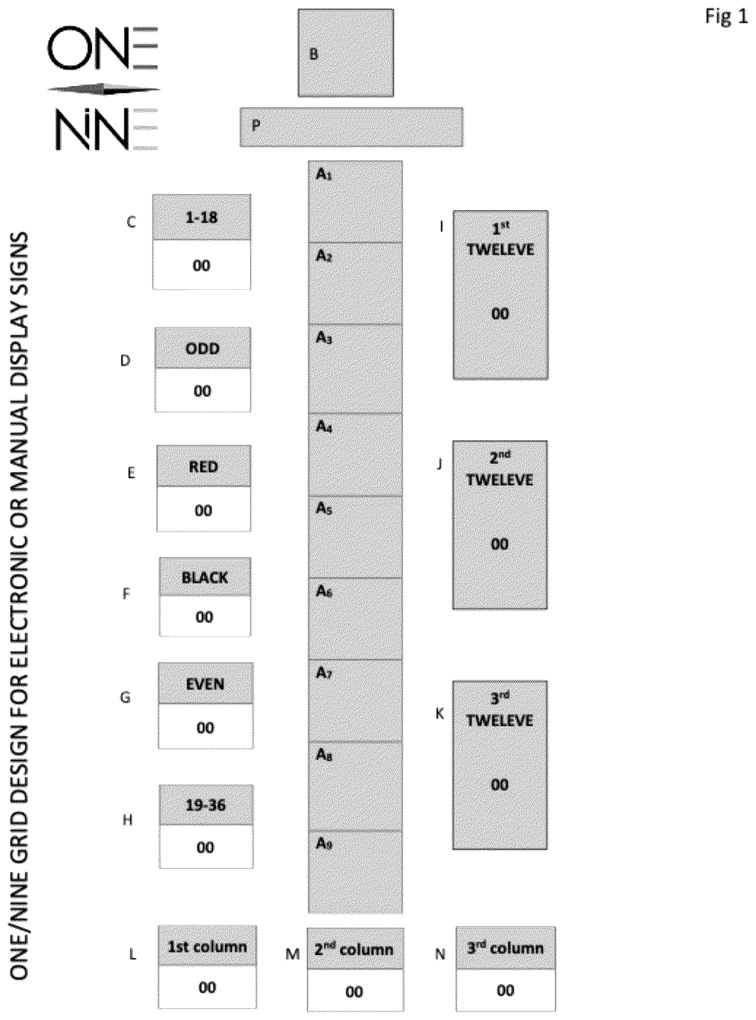

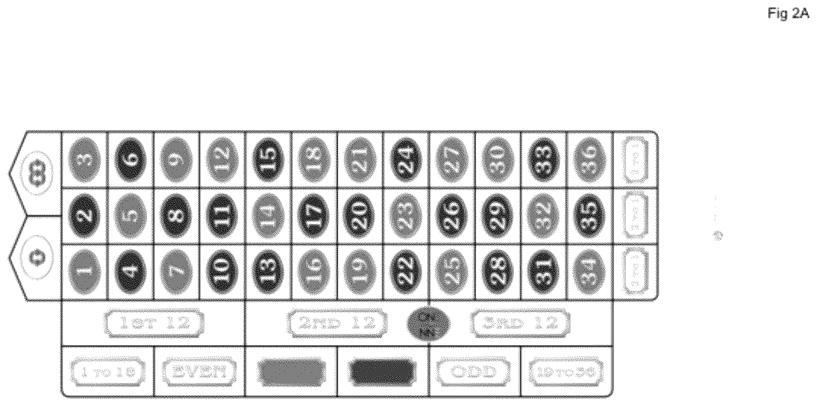

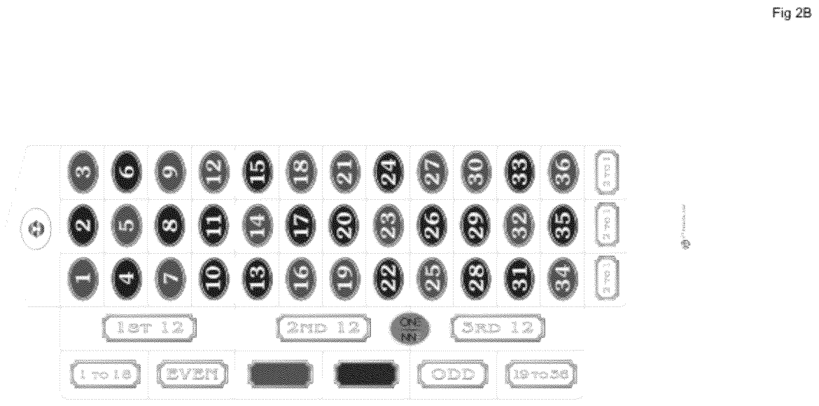

a) FIG. 1 and the accompanying key chart below: FIG. 1 is new and unique grid design, created specifically for the purpose of accommodating the invention One/Nine on a electronic display signage with automation software options for efficiency, and for better patron service. This FIG. 1 design can also be integrated to work on any currently existing third party electronic digital display signs, and for any manual keypad input digital electronic signs, as well as for a new and purpose made electronic digital display sign. This grid design is unique along with custom built software that will auto-manage the invention One/Nine on a display signage showing the most recent winning Nine distinct game outcomes in their ascending order of occurrence, It will automatically post the current or the 10th active winning game outcome, and the payout odds, which will only be posted if the 10th active winning game outcome is one amongst the most recent nine distinct game outcomes. The correct payout odds will be posted that are inline with the payouts chart that is predetermined and calculated based on the mathematical probabilities of possible distinct game outcomes. The grid design will also shows other outcomes such as the “outside wagering positions” as generally known in the traditional game of Roulette, as to how many times in the most recent game outcomes each of these outside wagering positions (1-18, odd, Red, Black, Even, 19-36, 1st, 2nd, 3rd group of twelve and 1st, 2nd, 3rd group of twelve columns) have come up. However these “outside wagering positions” inclusion on the grid design is not relevant to the invention One/Nine. This grid design can be modified to show more information, but for our purpose we are monitoring the most recent NINE winning distinct game outcomes, The 10th and active winning game outcome, and the relevant payout odds if the 10th active game outcome is amongst the posted most recent NINE winning distinct game outcomes. The fundamental design of the grid is integral to the invention One/Nine and its ease of functionality. Variations of the grid design FIG. 1, can be adopted, but the fundamental concept and the key purpose of the concept/method will remain true to our design claim, and the concept of the invention One/nine will also remain independently true, and uniquely innovative as described in our detailed description of the invention.

b) FIG. 2A and FIG. 2B There are two Figures of the Roulette game wagering layouts, and both of these wagering layouts showing the invention One/Nine wagering area where the patrons can place their wagers. Only the location of the One/Nine wagering area is unique. FIG. 2A shows the North-American version of the game of Roulette where the addition of the double zero “00” is present, along with the wagering space around the double “00” printed on the layout, and the same separate “00” pocket is on the actual North American roulette wheel as well. The FIG. 2B is the European/Asian version of the game of Roulette where there is only one wager area for the possible outcome of a single zero (0). Therefore there is only a single “0” position printed on the wagering layout, and the same single zero pocket is on the actual European/Asian roulette wheel. Our modification on the Roulette wagering layout is the addition of the One/Nine wagering area marked between the 2nd twelve area and the 3rd Twelve area of the both types of the Roulette game wagering layout.

### DETAILED DESCRIPTION OF THE INVENTION

### Overview

This documentation describes the invention titled One/Nine which will be offered to patrons who participate in playing a games-of-chance consisting of a sequence of games, where the outcome of each game has a statistically independent outcome.

An example of such a game is the game of Roulette, where the outcome of each game is a uniformly distributed random numbers on a Roulette wheel, from within the range of either 37 or 38 numbers possibilities (0+ numbers 1-36 totaling 37 number game of Roulette, and an addition of the double zero (00) pocket on a North-American style Roulette wheel with 0+00+ numbers 1-36 making the total of 38 number game of Roulette) note that there are two separate roulette games one that played on a 37 numbers Roulette wheel and the other on a 38 numbers Roulette wheel. The invention One/Nine is described in the context of both version of the game of Roulette, and therefore applicable to both Versions of the game of roulette.

Patrons of such games of chance study the historical game outcomes, sometimes assisted by an electronic display signage, or on a manual keypad input display signage, or simply by writing down the outcomes on a physical score card. The patrons at times make use of these historical game outcomes in determining the strategy, and to wager accordingly on occasions. Some patrons desire to wager on game outcomes which have come up more frequently in the past and other patrons will wager on outcomes which are less frequent. Such style of play is not advantageous or disadvantageous to the patrons as the element of chance still remains the same, but nevertheless, it is popular.

The invention titled One/Nine, allows the patrons to participate by easily placing a wager on the area marked One/Nine on the Roulette game wagering layout, and by doing so, are predicting that the next game outcome will be one amongst the most recent nine winning number's distinct game outcomes which are always posted were the invention One/Nine is played. If then the next or the 10th number game outcome is among the posted most recent Nine winning distinct game outcomes, then the patrons who have wagered on the One/Nine wagering concept method are winners, and are paid their winning amounts in accordance to the One/Nine rules and payouts chart.

The advantage of such add-on wagering concept to an existing games of chance, makes for an easy and simple concept for patrons to participate in, which can further enhance the popularity for the game of Roulette, increasing game participation, resulting to a possibility of increase in revenues. The margins from such an add-on wagering concept are generally in line or greater in most instances than from wagers placed on the base standard primary game itself, due to the way the payout structures are rounded off compared to the payout odds made for a bet on the base standard primary games. The detailed calculations of the One/Nine wagering concept method's probabilities and the payout odds are shown in the chart below.

The One/Nine wager could be played by placing either a chip, cash, or a digitally valued chip, on the designated area on the Roulette wagering layout where the One/Nine is print and marked on a Roulette gaming table's wagering layout, or on a electronic version of the Roulette as in the case of an online games, or as in a electronic Roulette gaming terminal version.

The game outcomes can be posted and managed manually, but it can also be managed by automation, simply by the use of an electronic display signage which detects and than registers the game outcome from the Roulette wheel and posts the distinct game outcomes on the monitor screen signage. or on a manual keypad inputted display signage. This types of signage will also be used to show the most recent Nine winning game outcomes in their ascending order, and the next upcoming (the 10th) game outcome, to show if the 10th outcome is One amongst the most recent Nine game outcomes. It can also display the appropriate payout odds in accordance with the predetermined probabilities, calculated in percentage, and the appropriate payout odds, mathematically calculated based on the methodology and the rules of the new invention One/Nine.

### Example Embodiment

The embodiment includes the payout rules and method of play, the payout chart, the modification to add the One/Nine wagering area on the Roulette game wagering layout, the new and unique grid design for any type of electronic display signage operated by custom software specifically coded for the Invention One/Nine wagering concept method, to achieve automation and visual display and the workings of the Invention One/Nine on a display sign.

The embodiment also includes the claimed new and unique grid design for display signage in FIG. 1.

The embodiment also includes the potential trade name and logo of the invention “One/Nine”.

### Rules

For the invention One/Nine concept method to be applied to a primary game of chance. The primary game of chance must produce a range of random, but statistically independent outcomes. However It is not necessary that these independent outcomes are uniformly distributed, but it is simpler to consider a concrete example a game such as the game of Roulette in which the numbers are uniformly distributed. Other non-uniformly distributed primary game outcomes can also be accommodated by this invention One/Nine, such as a game where the sum of a throw of several dice game outcomes, or the score of a card game outcomes, or just an independent score value and or a card suite from a single deck or multiple decks of playing cards game outcomes, or game outcome from a spin of a wheel like the “Big-6” game outcomes, or a “Wheel of Fortune” game outcomes, where a winning symbol or a score is determined from a specific range of possible scores or symbols that are positioned on a wheel to achieve random outcomes.

The game of Roulette produces a uniformly distributed random winning number game outcomes, by the method of spinning a roulette ball in the rim of a roulette wheel, and when the spinning ball comes to rest in one of the counter rotating numbered pockets which are situated below the rim on the Roulette wheel, only then the winning game outcome is identified by the numbered pocket in which the ball has come to rest. The traditional roulette wheels are typically made up off 37 or 38 numbered pockets including the pocket for zero (0) and or an additional pocket on the roulette wheel for a double zero (00). An electronic display signage or manual input display signage can be used to display the past winning game outcomes (most recent Nine game outcomes), and the next most current (10th) active winning game outcome. (range of numbers along with a (0) or and (00) are used in a typical game of Roulette to determine the winning game outcomes).

One embodiment of the invention titled “One/Nine” allows the patrons to wager on the proposition that the next (or the 10th) game outcome will match one of the displayed list of the past winning (N) numbers distinct game outcomes. However it must be noted that the same true fundamental concept of this invention is also applicable when and if the realistic embodiment of range is greater of lesser than (N). Therefore if the embodiment of (N) is increased or decreased, then the predetermined mathematical payout chart and the probability of the distinct numbers outcomes would reflect on to the payout odds to the winning wagers. Our invention would allow for such an increase or a decrease in the embodiment of (N) and its distinctions if need be, but the fundamental integrity, the concept and the method of our invention One/Nine does not change from its true concept and method.

Therefore if the result of the next (10th active winning number) game outcome, is one amongst the previous N number's distinct game outcome results, then the patron will be paid a multiple of their wager value, inline with the rules and payout chart shown below. If however the next (10th active winning number) game outcome result is not amongst the posted list of the previous N number's distinct game outcomes results, then the wager/s placed on the One/Nine designated wagering location is/are forfeited.

A realistic embodiment is where N=9.

The chance of the next (10th) winning number in the game of Roulette outcomes, from 37 or 38 possibilities of outcomes, is going to matching one of the most recent Nine listed outcomes is dependent on the groups of distinct outcomes from the most recent Nine independent outcomes history. If all previous Nine game outcomes results are (grouped) different, the probability that the next game outcome is included in the most recent Nine game outcome history is 9/37 (24.3%). However, it is possible (though unlikely) that the most recent Nine game outcome results are all the same number (single distinct group), in which case the probability of the next (10th) active number game outcome result being the same is 1/37 (2.7%). The most likely situation is where the most recent Nine game outcomes could contain 8 distinct results groups, or 7, or 6 distinct results groups, or less and the remaining 1, 2, 3 or more could be the repetition the remaining distinct outcomes are either in singular or plural.

The payout odds are dynamically determined for each possible winning game outcome based on the probabilities, and the payout chart calculations which are based on the distinction of the most recent Nine game outcomes. The payout chart is predetermined therefore must always be displayed in print at all time where the invention One/Nine wagering concept method is offered and played. So the patrons are made aware of all probabilities, outcomes, payout odds, as well as the win on the wager or the loss on their wagers in line with the Invention One/Nine rules of play during each game event. An electronic display signage, or manual input display signage will also be used, for the ease of calculation and visual authentication of the invention One/Nine where the display can auto calculate or manual key pad input calculate, and show these probabilities, outcomes, payout odds as well as the win on the wager or the loss on the wager in line with the invention One/Nine rules of play during each game event. The same display signs, and or manual keypad inputted sign will also post the next (10th) active winning number game outcome and the payout odds, if however the next (10th) active winning number game outcome is not amongst the most recent Nine winning outcomes, then the patron's wagers are forfeited and no payout odds are posted. Each (10th) active game outcome will get posted on the signage as it gets determined by the Roulette wheel and winning outcomes for the game of roulette are always determined by correctly functioning Roulette wheel.

The following chart shows the probability of number of distinct game outcomes, based on the Nine most recent numbers game outcomes, and the payout odds for possible winning wager/s that are inline with the probable distinct outcomes

| | Probability of this | Chance& | Payout odds |
|---|---|---|---|
| | number of distinct | likelihood of | for the |
| Distinct | outcomes being present | outcome in | ONE/NINE |
| Outcomes* | in recent history | percentages % | winning wager. |
| 1 | Negligible | 2.7% | 35:1 |
| 2 | Negligible | 5.4% | 17:1 |
| 3 | 0.000109% | 8.1% | 11:1 |
| 4 | 0.0945% | 10.8% | 8:1 |
| 5 | 0.280% | 13.5% | 6:1 |
| 6 | 3.41% | 16.2% | 5:1 |
| 7 | 18.4% | 18.9% | 4:1 |
| 8 | 43.1% | 21.6% | 3:1 |
| 9 | 34.7% | 24.3% | 3:1 |

Distinct Outcomes*: 1, meaning all 9 previous outcomes are of the same number from the range of 37 numbers (0 + 36) or 38 numbers(0 + 00 + 36).
2, meaning that all 9 previous outcomes are a combination of just 2 numbers from the range of 37 numbers (0 + 36) or 38 numbers (0 + 00 + 36).
3, meaning that all 9 previous outcomes are a combination of just 3 numbers from the range of 37 numbers(0 + 36) or 38 numbers (0 + 00 + 36).

The same is to be acknowledged when distinct game outcome is either combinations of 4, 5, 6, 7, 8, and 9 distinct numbers relating to the game of Roulette, while keeping track of these most recent Nine game outcomes that are dynamically changing proceeding each new game outcomes. Therefore the upcoming next outcome (or the ever-changing 10th game outcome) also called the “winning number” outcome will determine whether the wagers placed on the invention One/Nine is a winning wager or a loosing wager in accordance with the invention One/Nine rules of play, and its predetermined probabilities. The chart is based on the probabilities of each statistically independent game outcomes, and their distinction with in the Nine most recent game outcomes.

The typical payout on a roulette bet is determined by dividing 36 by the number of results covered by the wager, minus 1 (since the patron retains their wager if they win). So a standard wager on 4 numbers e.g. (a“corner bet”) has a payout of (36/4)-1 or 8 to 1. On a standard roulette wagering layout, it is usually only possible to wager on 1, 2, 3, 4, 6, 12 or 18 numbers with single wager (exception on a 38 number game of roulette, 5 numbers can be covered with one wager those five numbers being 0, 00, 1, 2 and 3), and these numbers all divide into 36, therefore the operator's margins on such wagers are constant.

The invention One/Nine, is also a single wager proposition, covering the probability that the next upcoming winning outcome will be matching any one of the most recent Nine winning game outcomes. The Nine most recent outcomes are continuously changing after each game outcome event is concluded, where the most recent Nine game outcome will change as the (10th) winning game outcome will replace the 1st of the most recent game outcome, thus creating new most recent Nine game outcomes after each game event is concluded, and before the new game event begins. However within this Nine group of ever-changing outcomes, not all of the Nine distinct probabilities divide into the 36 exactly for the game of Roulette, therefore the payout odd is rounded down to the lower integer. This causes an increased operator advantage when playing the invention One/Nine, when compared to standard single zero (0) roulette game where the operator advantage is at (2.7%), and the two zero (0) (00) roulette game where the operator advantage is at (5.26%) and the operator advantage for the Invention One/Nine is at approximately 7.9% on a single zero (0) roulette game, and approximately 9.1% on a two zeros (0) (00) roulette game.

In the above payouts chart, the outcomes which pay out exactly the same as standard roulette are in bold, and those where the payout is rounded down, giving increased margins to the operator, are in normal text.

### Gaming Layout

The modifications to the roulette game wagering (betting) layout is required. So a designated wagering area/spot can be marked One/Nine for the patrons to place their wagers on this specifically marked area/spot. The trade name of “ONE/NINE” and or other markings can be used to distinguish this modification to the standard roulette game wagering (betting) layouts, and/or on a digital screen. An example image of such marked Area/Spot is attached as FIG. 2A and FIG. 2B.

### Electronic Display Signage

The new and unique “One/Nine” grid design for electronic display signage and the design's, automation functionality software, can be installed on any third-party signage that are currently in use, and or on new purpose made electronic display signage as required. This new and unique electronic display signage will help further enhance the One/Nine invention's overall efficiency, user integration, and the path way to greater participation. These display signs, will also help automate and further enhance the One/Nine invention in achieving speed of accuracy, user satisfaction, and data collection for meaningful analytics. These visual display signage can also be used for various marketing and in-house promotions. The new and unique grid design provided in FIG. 1, will be part of our design claim and or dependent claim for the invention One/Nine, as appropriate.

### ONE/NINE FIG. 1 Key Chart

### Keys

A1-A9—will show the most recent Nine winning number outcomes in their ascending order.
B—will show the current active winning number or it could also be called the 10th winning number,
C—indicates the 1-18 or the low numbers that are positioned on the Roulette wheel. Also printed on the layout/cloth.
D—indicates the ODD numbers between 1 and 36 that are positioned on the Roulette wheel. Also printed on the layout/cloth
E—indicated the RED numbers between 1 and 36 that are positioned on the Roulette wheel. Also printed on the layout/cloth.
F—Indicates the Black numbers between 1 and 36 that are positioned on the Roulette wheel. Also printed on the layout/cloth
G—indicates the EVEN numbers between 1 and 36 that are positioned on the Roulette wheel. Also printed on the layout/cloth
H—indicates 19-36 or the high numbers that are positioned on the Roulette wheel. Also printed on the layout/cloth,
I—indicates 1st Twelve, or the 1st Dozen numbers 1-12. Positioned on the roulette wheel. Also printed on the layout/cloth.
J—Indicates 2nd Twelve, or the 2nd Dozen numbers 13-24. Positioned on the roulette wheel also printed on the layout/cloth
K—indicates 3rd Twelve, or the 3rd Dozen numbers 25-36 positioned on the Roulette wheel. Also printed on the layout/cloth
L—indicates The 1st column and the 12 numbers positioned on the Roulette wheel. Also printed down in line from number 1 on the layout/cloth
M—indicates The 2nd column and the 12 numbers positioned on the wheel. Also printed down in line from number 2 on the layout/cloth.
N—indicates The 3rd column and the 12 numbers positioned on the wheel. Also printed down in line from number 3 on the layout/cloth.
P—will post the payout odds if the current winning number or the 10th number (B) is one of the nine most recent winning numbers.
(00) will show the actual number of times that each of these combinations or their categories has come up in the most recent 1-9 or the most recent 1-20 game outcomes.

1. The invention ONE/NINE is an innovative and valid method, for a new and unique proposition wager, intended as an addition to an existing primary game of chance, which must produce a sequence of outcomes, that are random and statistically independent, from a range of outcomes that are uniformly or non-uniformly arranged, the game of roulette is such a game of chance, where an independent outcome is randomly produced from a field of 37 or 38 uniformly distributed possible outcomes, the random generation can be done by the method of using a wheel like apparatus and a ball, or by the use of a software driven random generation method,
the invention claims that by grouping the nine most recent such independently produced outcomes, within their ever-changing dynamic cycle,
the group of nine most recent outcomes, and the active outcome are visually displayed on a electronic signage, a grid designed specifically for such electronic signage is dependent of the invention,
this will produce nine probabilities of distinct outcomes that are individually unique in their probable outcome therefore offering varying multiple payout odds on a proposition wager covering the nine probabilities as they change,
as each new outcome becomes part of the proceeding nine most recent outcomes and so forth,
the distinction within the nine outcomes always changing, creates nine distinct probabilities for a proposition wager
for predicting, thus the next upcoming independent outcome will match one of the nine most recent outcomes and be rewarded the winning multiple
payout odds matching one of the nine distinct outcomes,
The invention is dependent on the grid design of drawing-1, for a manual or auto-input electronic visual signage, to provide visual monitoring of invention ONE/NINE and to maintain an accurate track of the nine most recent outcomes, as well as to post the one most recent independent outcome and to post the correct payout odds from the predetermined payout chart (drawing-3), it will also provide visual and accurate postings of the ONE/NINE outcomes, so patrons can stay visually informed at all times relative to the invention ONE/NINE and the game of roulette; the invention ONE/NINE claims that the nine most recently produced independent outcomes in a game of chance, which are always in a dynamically changing cycle of nine distinct outcomes, thus mathematically generating the nine uniquely distinct probabilities which then creates the option for a proposition wager, proposing that the proceeding one outcome will match one of the most recent nine outcomes which would result in awarding the winning odds against the distinct predicted outcome, the winning payout odds are predetermined based on the nine distinct probable outcomes.
